(19) United States
(12) Patent Application Publication
(10) Pub. No.: US 2015/0003804 A1
(43) Pub. Date: Jan. 1, 2015

(54) DATA PLAYBACK METHOD AND HANDHELD DEVICE SUPPORT USING SAME

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: MIN YANG, Wuhan (CN); JIAN-HUNG HUNG, New Taipei (TW)

(21) Appl. No.: 14/314,571

(22) Filed: Jun. 25, 2014

(30) Foreign Application Priority Data
Jun. 27, 2013 (CN) 201310260517X

(51) Int. Cl. H04N 5/765; G11B 31/00

(52) U.S. Cl. CPC H04N 5/765; G11B 31/00
USPC 386/230

(57) ABSTRACT

A computer-aided method executed on a handheld device support is disclosed. The method allows the handheld device support to read data from a mobile storage device coupled to the handheld device support and transmits the data and commands capable of automatically opening a corresponding data playback program installed on a handheld device to the handheld device supported by the handheld device. Upon receiving the data and the commands from the handheld device support, the handheld device automatically open the data playback program to play the received data.

### CROSS-REFERENCE TO RELATED APPLICATIONS

This application claims priority to Chinese Patent Application No. 201310260517.X filed on Jun. 27, 2013 in the China Intellectual Property Office, the contents of which are incorporated by reference herein.

### FIELD

Embodiments of the present disclosure generally relate to a data playback method and a handheld device support using the data playback method.

### BACKGROUND

The use of handheld devices, for example, mobile phones or tablet computers, a Palm PC, a personal digital assistant, or any of a variety of other types of handheld devices, has expanded rapidly in the past few years, and many members of the public now have their own personal mobile devices for private and business use.

Sometimes, for example, when sitting in a sofa or driving a car, people wishes to “hands free” use their handheld devices. Recently “hands-free” accessories haven been made available. Commonly, hands-free accessories can include handheld device supports. In the early stages, some handheld device supports can be used only to support the handheld device so as to free user's hands. Recently, a multifunctional handheld support is needed to provide a variety of functions to the handheld device. The functions can includes providing power charging to the mobile computing device's rechargeable battery and providing a digital connection between the mobile computing device and a personal computer.

### BRIEF DESCRIPTION OF THE DRAWINGS

Implementations of the present technology will now be described, by way of example only, with reference to the attached figures, wherein:

FIG. 1 is a block diagram of an exemplary embodiment of a handheld device and a handheld device support in a possible use environment.

FIG. 2 is a schematic diagram of an exemplary embodiment of a handheld device support.

FIG. 3 is a block diagram of an exemplary embodiment of a data playback system.

FIG. 4 is a flowchart of an exemplary embodiment of a data playback method of a handheld device support.

FIG. 5 is a flowchart of an exemplary embodiment of a data playback method of a handheld device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

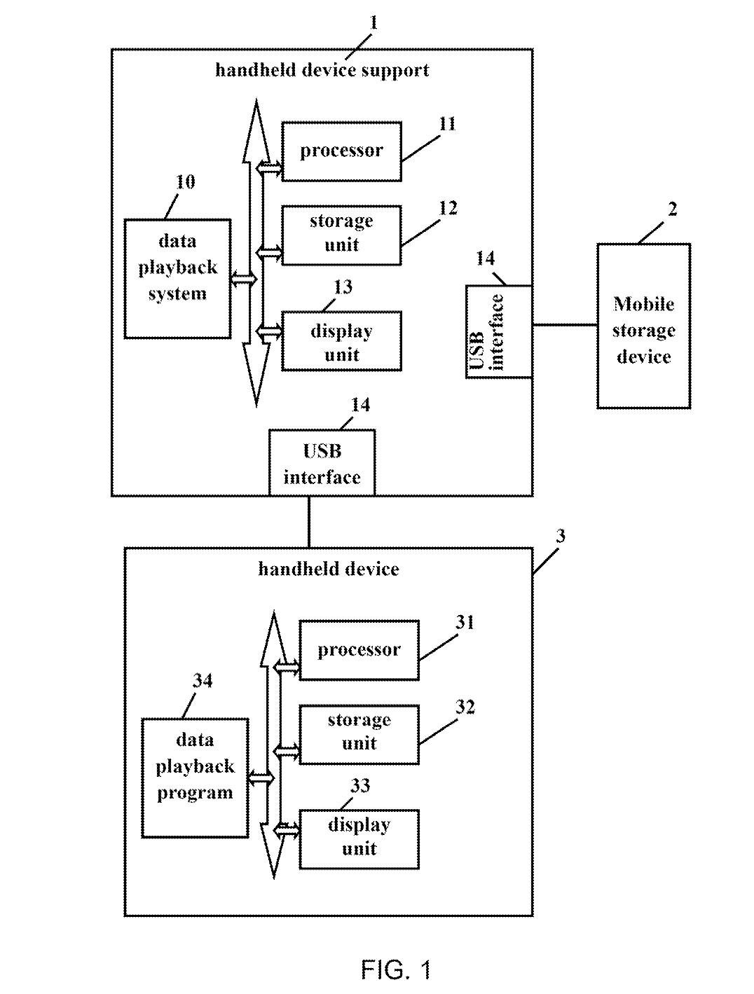

FIG. 1 is a block diagram of an exemplary embodiment of a handheld device and a handheld device support in a possible use environment. A handheld device support 1 can be used to support a handheld device 3. The handheld device 3 can be a mobile phone, a tablet computer, a Palm PC, a personal digital assistant, or any of a variety of other types of handheld device. The handheld device support 1 can be coupled to the handheld device 3 or to a mobile storage device 2 via an interface 14. The interface 14 can be a universal serial bus (USB) port. In other embodiments, the interface 14 can be a PCI slot, a HDMI port, or a memory card slot, and etc. The mobile storage device 3 can be a USB driver, a memory card, or a mobile hard disk drive.

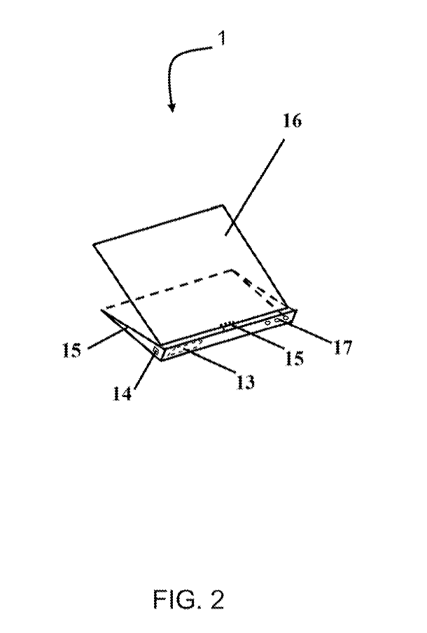

Referring to FIG. 2, the handheld device support 1 can include a base 15, a support frame 16, a plug-in 17, a plurality of buttons 17, and at least one interface 14. The support frame 16 is configured on the base 15 for supporting a handheld device thereon. The plug-in 17 can be configured to be capable of being inserted into an interface of the handheld device 3 when the handheld device 3 is supported by the handheld device support 1. The display unit 13 is configured on the base 15 for displaying the data obtaining from the mobile storage device 2. The display unit 13 can be a light emitting diode (LED) display. The plurality of buttons 18 are configured on the base 15 for receiving commands from a user when being pressed by the user. The buttons 18 can include a “power” button, an “up” button, a “down” button, an “enter” button, and a “cancel” button. In other embodiments, the plurality of buttons 18 can be virtualized buttons displayed on the display unit 13. In other embodiments, the handheld device support 1 can be coupled to the handheld device 3 via other ways, for example, wireless networks or a cable connection.

The handheld device support 1 can further include a processor 11, a storage unit 12. The storage unit 12 can be used for storing user data, operating system or application programs of the handheld device support 1. The processor 11 can be used for performing the operating system or application programs stored in the storage unit 12. In an exemplary embodiment, a data playback system 10 can be stored in the storage unit 12 and can be performed by the processor 11.

The handheld device 3 can include a processor 31, a storage unit 32, a display unit 33. The storage unit 12 can be used for storing user data, operating system or application programs of the handheld device 3. The processor 31 can be used for performing the operating system or application programs stored in the storage unit 32. In an exemplary embodiment, at least one data playback program 34 can be stored in the storage unit 12 and can be performed by the processor 11. The data playback program 34 can be a general program for playing video, audio or pictures.

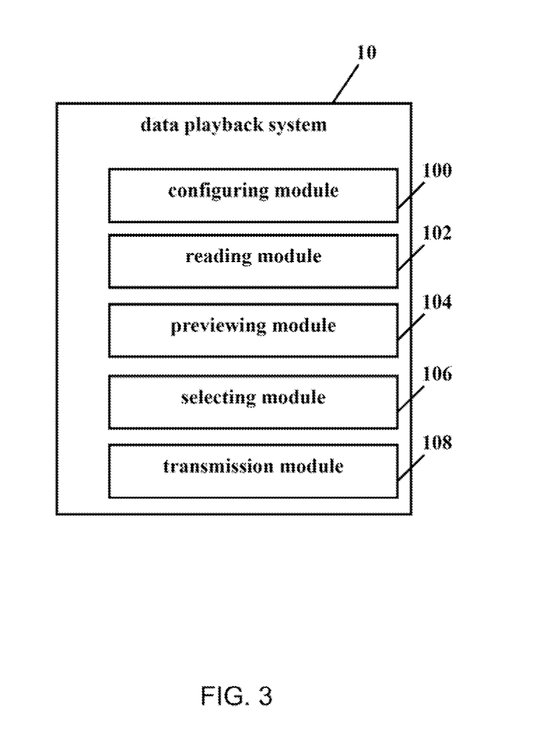

Referring both to FIG. 1 and FIG. 3, the data playback system 10 can include computerized instructions in the form of one or more programs that are executed by the processor 11 and stored in the memory 12. In at least one embodiment, the data playback system 10 can include one or more modules, for example, a configuring module 100, a reading module 102, a previewing module 104, a selecting module 106, a receiving module 108, and a triggering module 109. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The configuring module 100 can be configured to preset controlling parameters. The controlling parameters can be used for controlling the data playback program 34 of the handheld device 3. The controlling parameters can include playing start time, playing end time, playing mode, and etc. The reading module 102 can be configured to read data from the mobile storage device 2. The previewing module 104 can be configured display the data obtained from the mobile storage device 2 in a preview mode. The data read from the mobile storage device can be pictures, video, audio, animation, text. For example, if the data obtained from the mobile storage device is pictures, thumbnail of the pictures will be displayed on the display unit 13. If the data obtained from the mobile storage device is video or audio, outline of the data will be displayed on the display unit 13. The selecting module 106 can be configured to confirm selected data based on a user's input. For example, a user can press a button configured on the handheld device support 1 to select data to be played, and then the selecting module 106 confirmed the selected data in response to the pressed button. The transmission module 108 can be configured to transmit the selected data, commands and controlling parameters to the handheld device 3. The commands can be used for opening the data playback program 34 of the handheld device 3.

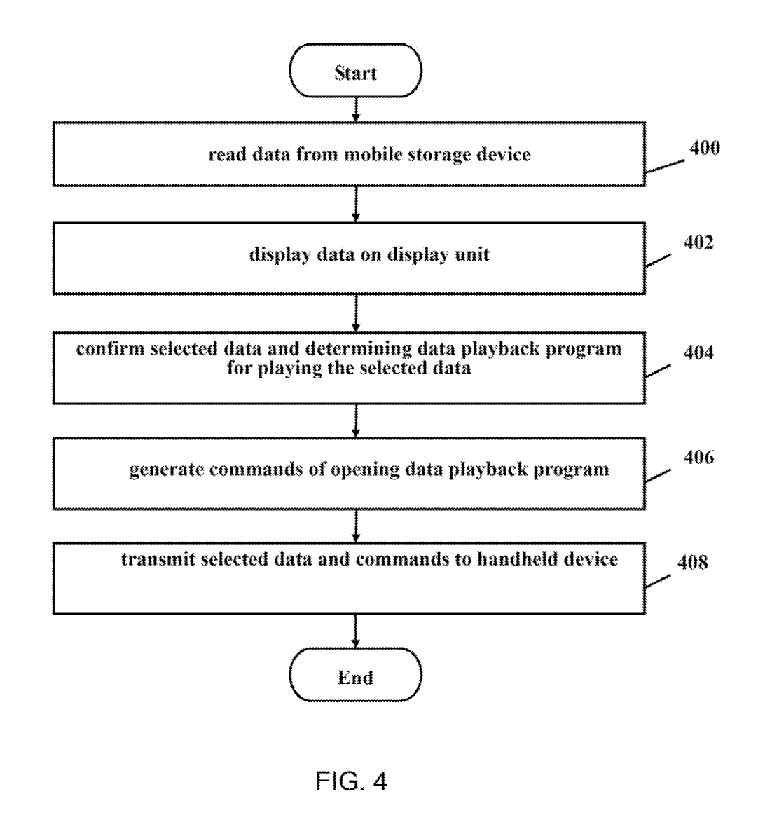

FIG. 4 illustrates a flowchart of an exemplary embodiment of a data playback method of a handheld device support. At block 400, the handheld device support reads data from a mobile storage device when a connection between the handheld device and the mobile storage device is established. The data read from the mobile storage device can be pictures, video, audio, animation, text.

At block 402, the data read from the mobile storage device is displayed on a display unit of the handheld device support in a preview mode. Under the preview mode, thumbnail or outline of the data is displayed. A user can select data to be played from the displayed data by pressing corresponding buttons configured on the handheld device support.

At block 404, the selected data is confirmed in response to the pressed buttons. The handheld device support determines which data playback program can be used to play the selected data based on the type of the selected data. The data playback program can be a general audio player, a general video player, a general animation player or a general text viewer.

At block 406, the handheld device support generates commands of opening the data playback program. The commands can be transmitted to a handheld device for automatically opening the data playback program installed on the handheld device.

At block 408, the handheld device support transmits the selected data and the commands to the handheld device so as to automatically open the data playback program for playing the selected data in the handheld device.

In at least one embodiment, at block 404, a user can preset some controlling parameters for controlling the data playback program of the handheld device. The controlling parameters can include playing start time, playing end time, playing mode, and etc. The controlling parameters can be transmitted together with the selected data and the commands to the handheld device.

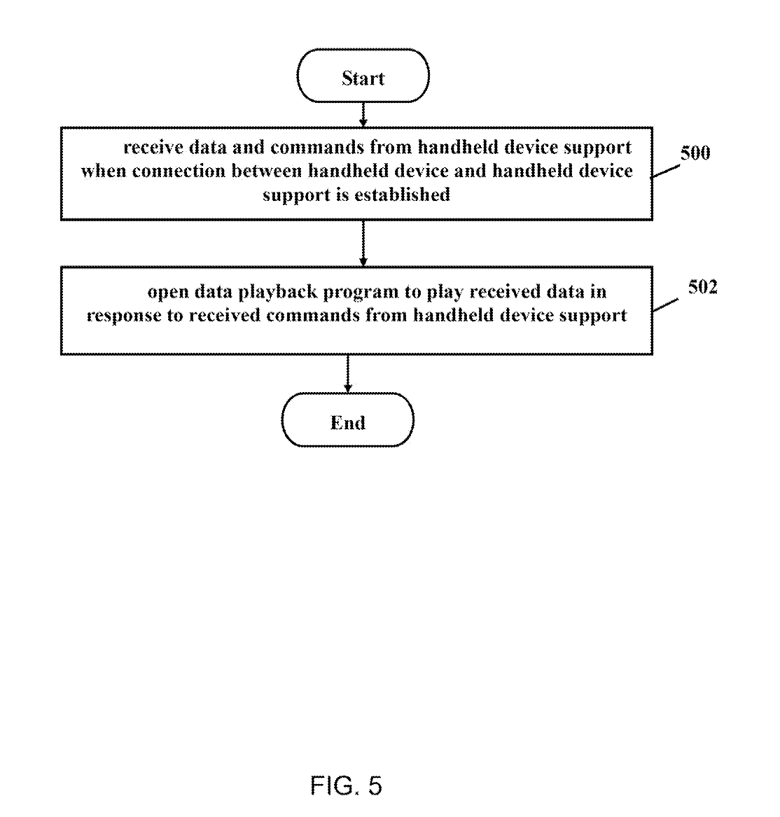

FIG. 5 is a flowchart of an exemplary embodiment of a data playback method of a handheld device. At block 500, the handheld device receives data and commands from a handheld device support which is configured to support the handheld device when a connection between the handheld device and the handheld device support is established. At block 502, the handheld device opens a corresponding data playback program installed on the handheld device to play the received data in response to the received commands. The received data can be pictures, video, audio, animation or text. The data playback program can be a general audio player, a general video player, a general animation player or a general text viewer.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the scope of the following claims.

What is claimed is:

1. A data playback method for a handheld device support, the handheld device support configured to support a handheld device, the method comprising:
reading data from a mobile storage device when a connection between the handheld device support and the mobile storage device is established;
displaying data on a display unit of the handheld device;
confirming selected data to be displayed in response to an input selection;
determining a corresponding data playback program installed on the handheld device to be used for playing the selected data based on a type of the selected data;
generating commands being capable of automatically opening the data playback program, and
transmitting the selected data and the commands to the handheld device.

2. The method according to claim 1, further comprising: configuring controlling parameters configured to control the data playback program.

3. The method according to claim 1, wherein the controlling parameters include playing start time, playing end time, and playing mode.

4. The method according to claim 1, wherein the controlling parameters includes playing start time, playing end time, playing mode.

5. The method according to claim 1, wherein the selected data is one of pictures, video, audio, and animation.

6. The method according to claim 1, wherein “displaying data on a display unit of the handheld device” comprising: displaying thumbnail or outline of the data on the display unit.

7. A handheld device support, comprising:
an interface configured to connect a mobile storage device;
a support frame configured to support a handheld device thereon;
a display unit;
a storage unit for storing instructions; and
a processor for executing the instructions to performing a method, the method comprising:
reading data from the mobile storage device when a connection between the handheld device support and the mobile storage device is established;
displaying data on the display unit;
confirming selected data to be displayed in response to an input;
determining a corresponding data playback program to be used for playing the selected data based on a type of the selected data;
generating commands configured to automatically open the data playback program installed on the handheld device; and
transmitting the selected data and the commands to the handheld device.

8. The handheld device support according to claim 7, wherein the method further comprises: configuring controlling parameters configured to control the data playback program.

9. The handheld device support according to claim 7, wherein the controlling parameters include playing start time, playing end time, and playing mode.

10. The handheld device support according to claim 7, wherein the controlling parameters are transmitted together with the selected data and the commands to the handheld device.

11. The handheld device support according to claim 7, wherein the selected data is one of pictures, video, audio, and animation.

12. The handheld device support according to claim 7, wherein “displaying data on a display unit of the handheld device” comprising: displaying thumbnail or outline of the data on the display unit.

13. The handheld device support according to claim 7, wherein the interface is a universal serial bus port.

14. A handheld device, configured to support a handheld device support, the handheld device comprising:
a storage unit for storing instructions; and
a processor for executing the instructions to performing a method, the method comprising:
receiving data and commands from the handheld device support; and
opening automatically a corresponding data playback program to play the received data in response to the received commands from the handheld device support.

15. The handheld device according to claim 14, wherein the received data is selected from pictures, video, audio, and animation.
